(19) United States
(12) Patent Application Publication
(10) Pub. No.: US 2013/0036614 A1
(43) Pub. Date: Feb. 14, 2013

(54) INVOLUTE SLICER

(71) Applicant: Christopher D. Seigneur, West Linn, OR (US)

(72) Inventor: Christopher D. Seigneur, West Linn, OR (US)

(73) Assignee: Blount, Inc., Portland, OR (US)

(21) Appl. No.: 13/570,514

(22) Filed: Aug. 9, 2012

Related U.S. Application Data
(60) Provisional application No. 61/522,187, filed on Aug. 10, 2011.

(51) Int. Cl. A01G 3/08; B26B 15/00; B26B 29/00

(52) U.S. Cl. 30/151; 30/240; 30/228

(57) ABSTRACT

Embodiments herein provide an involute slicer having a body portion and a blade coupled to the body. The involute slicer may further include an anvil to provide structural support to a workpiece. The blade may rotate about an axis. As the blade rotates, the blade may pass next to the anvil, thereby cutting the workpiece. The blade may include a cutting edge with a radius that increases from a proximal end to a distal end of the cutting edge. For example, the cutting edge may have an involute shape. The involute shape of the cutting edge provides a radially expanding cutting edge as the blade is rotated. In some embodiments, the blade may include a plurality of cutting edges, such as two cutting edges.

### CROSS REFERENCE TO RELATED APPLICATIONS

The present application claims priority to U.S. Provisional Patent Application No. 61/522,187, filed Aug. 10, 2011, entitled “INVOLUTE SLICER,” the entire disclosure of which is hereby incorporated by reference in its entirety.

### TECHNICAL FIELD

Embodiments herein relate to the field of slicers, and, more specifically, to an involute slicer.

### BACKGROUND

Woody or green stems are often cut with saw teeth that remove small chips with each pass. Many passes of the blade are required to cut through a stem, lengthening the cutting time. In addition the operator must force the tool against the stem to maintain cutting which fatigues the operator's hand and/or arm. Small stems with little support are easily deflected or get caught between teeth and thus cannot be effectively cut.

Woody or green stems are also cut with pruners that have either a straight blade that pinches the stem against an anvil or by passing blades that are curved. Either type requires high forces to sever the fibers because they employ a shearing action on the stems. The high cutting force fatigues the user's hand or if motor powered, requires large, and heavy, motors and gears.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIGS. 1A-1D illustrate perspective views of an involute slicer as a blade of the involute slicer travels from a starting position to a finishing position to cut a workpiece. FIGS. 1A-1D show the blade in: (A) a starting position; (B) a first intermediate position; (C) a second intermediate position; and (D) a finishing position, respectively, in accordance with various embodiments.

FIG. 1E illustrates a side view of an involute slicer cutting a workpiece, in accordance with various embodiments.

FIG. 2A illustrates a perspective view of an involute slicer in accordance with various embodiments.

FIG. 2B illustrates another perspective view of the involute slicer of FIG. 2A, in accordance with various embodiments.

FIG. 2C illustrates a perspective view of the involute slicer of FIG. 2A with a blade of the involute slicer in a starting position and prepared to cut a workpiece, in accordance with various embodiments.

FIG. 2D illustrates a side view of the involute slicer of FIG. 2A with the blade in a starting position and prepared to cut a workpiece, in accordance with various embodiments.

FIG. 2E illustrates a side view of the involute slicer of FIG. 2A with the blade in an intermediate position as the blade cuts a workpiece, in accordance with various embodiments.

FIGS. 3A-3D illustrate a side view of an involute slicer as a blade of the involute slicer moves from a starting position to a finishing position to cut workpieces of varying sizes. FIGS. 3A-3D show the blade in: (A) a starting position; (B) a first intermediate position; (C) a second intermediate position; and (D) a finishing position, respectively, in accordance with various embodiments.

FIG. 4A illustrates a side view of a blade having a pair of involute cutting edges with a plurality of regions having different ratios of radial expansion versus tangential travel in accordance with various embodiments.

FIG. 4B illustrates a side view of the blade of FIG. 4A with a cross-sectional view of a workpiece showing how the workpiece is cut at various increments of rotation of the blade in accordance with various embodiments.

FIG. 5A illustrates a perspective view of a slicer with a vertical blade orientation and the blade in a starting position in accordance with various embodiments.

FIG. 5B illustrates a side view of the slicer of FIG. 5A with the blade in an intermediate position in accordance with various embodiments.

FIG. 6A illustrates a perspective view of a slicer with a horizontal blade orientation in accordance with various embodiments.

FIG. 6B illustrates a top view of the slicer of FIG. 6A with a top cover of a protective sheath removed to show the blade in accordance with various embodiments.

FIG. 7A illustrates a side view of a back side of a blade having a relief portion in accordance with various embodiments.

FIG. 7B illustrates a cross-sectional view of the blade of FIG. 7A along line A-A of FIG. 7A.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In various embodiments, methods, apparatuses, and systems for an involute slicer are provided.

Embodiments herein provide an involute slicer having a body portion and a blade coupled to the body. In various embodiments, the involute slicer may further include an anvil to provide structural support to a workpiece. The blade may rotate about an axis. As the blade rotates, the blade may pass next to the anvil, thereby cutting the workpiece. In various embodiments, the blade may include a cutting edge with a radius that increases from a proximal end of the cutting edge to a distal end of the cutting edge. For example, the cutting edge may have an involute shape.

The term “involute” as used herein refers to a curve that is defined by the locus of a point at the end of a taut string being unwound (or wound) from another curve in the plane of the another curve. Thus, a radius of the cutting edge (i.e., the distance from the cutting edge to the axis of rotation) may increase from a proximal end of the cutting edge to a distal end of the cutting edge. In some embodiments, the shape of the cutting edge may approximate the involute of a circle.

In various embodiments, the involute shape of the cutting edge provides a radially expanding cutting edge as the blade is rotated. The blade advances into the workpiece while also having a component of motion tangential to the cutting edge. The tangential motion may decrease the force necessary to cut through the workpiece. In one experiment, it was found that a conventional blade required about 300 pounds of force to cut through a workpiece with a 0.5 inch diameter. With the involute slicer including a blade with a cutting edge having an involute shape, the blade required about 100 to 150 pounds of force to cut through a workpiece with a 0.5 inch diameter.

The slicer as described herein may be any type of cutting device, such as a pruner for cutting stems and/or branches of plants. The workpiece may be any suitable workpiece that is desired to be cut, such as, but not limited to, a stem, branch, and/or other portions of a plant, and/or other types of wood, plastic, and/or metal workpieces, such as a dowel, and/or a pipe. The cutting edge may be any suitable type of cutting edge, such as smooth, serrated, and/or having teeth. The type of cutting edge may be selected based on the intended workpieces to be cut. In some embodiments, the cutting edge may include more than one type of cutting edge, e.g., a portion having teeth and a portion that is smooth. In some embodiments, the blade may be removable and may be replaced with another blade. For example, the blade may be replaced when the cutting edge becomes dull or damaged, or to substitute a blade having a cutting edge with different properties or configured for a different cutting application.

In some embodiments, the ratio of radial expansion (shearing) versus tangential travel (slicing) of the cutting edge (i.e., the rate at which the radius of the cutting edge increases along the length of the cutting edge) may be configured/selected for the type of workpieces to be cut. For example, a high ratio of radial expansion versus tangential travel of the cutting edge may allow a workpiece of a given size to be cut more quickly (with less rotation of the blade), but require more force, than a cutting edge having a lower ratio of radial expansion versus tangential travel. Accordingly, a cutting edge having a higher ratio may be suitable for shearing smaller diameter workpieces, where reducing the required force is not as important, to allow smaller diameter workpieces to be cut more quickly. A cutting edge having a lower ratio may be suitable for slicing larger diameter workpieces to reduce the amount of force necessary to complete the cut.

The ratio of radial expansion versus tangential travel may also be defined by the radius of the reference curve used to define the involute curve. For example, an involute of a higher radius curve may have a higher ratio of radial expansion versus tangential travel compared with the involute of a lower radius curve.

In some embodiments, the blade may include a plurality of regions, and the cutting edge may have a different ratio of radial motion versus tangential motion within each region. For example, in a first region, at an end of the cutting edge where the radius is smallest, the cutting edge may have a first ratio with relatively high radial expansion versus tangential travel. The high first ratio may allow the blade to quickly shear through smaller diameter workpieces that do not require high force to cut through. In some embodiments, the first region may also be used to start cutting larger workpieces, since the workpiece has a smaller cross-sectional length at the start of the cut.

In a second region, in which the radius of the cutting edge is larger than in the first region, the cutting edge may have a second ratio with less radial expansion versus tangential travel compared with the first ratio. The lower second ratio may be especially suitable for slicing larger diameter solid workpieces (which typically require higher force to cut through), to allow the cutting edge to cut through larger workpieces with less force required.

In some embodiments, the blade may include a third region in which the radius of the cutting edge is larger than in the second region. The cutting edge in the third region may have a third ratio of radial expansion versus tangential travel. In various embodiments, the third ratio may be higher than the second ratio. The high ratio of the third region may be suitable for finishing cuts of larger solid workpieces that were started in the first region and/or second region. Accordingly, the second region may cut through the center of the solid workpiece when more force is needed, and the third region may be used to quickly finish the cut when less of the workpiece remains to be cut. In some embodiments, the ratio of radial expansion versus tangential travel of the third region may be the same as the ratio in the first region. In other embodiments, the ratio in the third region may be higher or lower than the ratio in the first region.

In some embodiments, the ratios and/or arrangement of the regions may be selected based on the type of workpieces to be cut. For example, a cutting edge with the ratio of the second region lower than the ratio of the first region may be suitable for solid workpieces, since the cross-sectional area of the cut is higher in the middle of the cut. In other embodiments, the ratio of the second region may be higher than the ratio of the first region. This arrangement may be suitable, for example, for hollow workpieces, such as tubes and/or pipes. For hollow workpieces, the highest cross section of the cut may occur at the beginning and/or end of the cut. The lower ratio of the first region may score the hollow workpiece and/or start the cut. The higher ratio of the second region may then cut through the middle portion of the workpiece relatively quickly. In some embodiments, the third region may have a ratio lower than the second region to finish the cut of the hollow workpiece (e.g., where the cross-section may be larger) furthest from the axis of rotation.

The blade may have one or more transition portions between different regions. The transition portions may be a smooth transition from the first ratio to the second ratio (i.e., the ratio changes gradually from the first ratio to the second ratio), or may step directly from the first ratio to the second ratio.

In some embodiments, other characteristics of the blade and/or cutting edge may vary between one or more regions of the blade. For example, one region of the blade may have a smooth cutting edge, and another region of the blade may have a serrated cutting edge.

In some embodiments, the blade may include a sliding surface and a relief portion on a back side of the blade that faces the anvil. The sliding surface may be adjacent the cutting edge and may contact the anvil as the blade rotates. The relief portion may be recessed from the sliding surface away from the anvil. The relief portion may facilitate a lower cutting force and/or provide a straighter cut compared with blades that are flat on the back side.

In some embodiments, the blade may include a plurality of cutting edges. The cutting edges may be coplanar and configured to rotate about the same axis. Each of the cutting edges may have an involute shape as described herein. For example, in one embodiment, the blade may include a pair of involute cutting edges disposed opposite one another about a central mounting hole that defines the axis of rotation. The blade with two cutting edges may cut a workpiece in half (or less) of a rotation of the blade. Furthermore, the blade may not need to rotate all the way back to the starting position to cut another workpiece. Rather, the second cutting edge may be used to cut a subsequent workpiece.

In some embodiments, the anvil of the involute slicer may have one or more pockets for holding and/or providing support for workpieces. For example, the pocket may have a curved concave shape, such as a semi-circular shape. In some embodiments, the anvil may have at least two pockets, with each pocket configured to hold a workpiece of a different size and/or range of sizes. A smaller pocket may be located closer to the blade and/or blade axis, allowing smaller workpieces to be cut with less rotation of the blade (i.e., without rotating the blade all the way to the finishing position), thereby reducing cutting time. A larger pocket may be located further from the blade than the smaller pocket, allowing extra space between the anvil and the blade for larger workpieces.

In some embodiments, the anvil may be stationary, and the blade may pass next to the anvil to cut the workpiece. In other embodiments, the anvil may rotate when the blade rotates. In these embodiments, the anvil may rotate in a direction opposite the rotation of the blade.

In some embodiments, the anvil may include a support structure on one or more sides of the blade to provide support to the workpiece. For example, the anvil may include one or more pockets on a first side and/or a second side of the blade. In some embodiments, the anvil may include a smaller pocket and a larger pocket on the first side of the blade, but only a smaller pocket on the second side of the blade, opposite the first side. The two smaller pockets may provide support for smaller workpieces which may be more flexible and require more support. Larger workpieces may be more rigid, and may not require support on both sides of the blade. However, in some embodiments, the anvil may include larger pockets and smaller pockets on both sides of the blade. In other embodiments, the anvil may include a support structure on only one side of the blade.

In some embodiments, the blade may include a cutout portion between the ends of the involute cutting edge. The cutout portion may allow a longer possible length for the cutting edge, while still allowing workpieces to be placed in the pockets.

In various embodiments, the involute slicer may be hand powered and/or motor powered. In embodiments in which the involute slicer is hand powered, the slicer may include one or more handles and/or levers to drive the rotation of the blade.

In embodiments in which the involute slicer is motor powered, the slicer may include any suitable motor, such as an electric motor, a battery-powered motor, and/or a gas motor. In some embodiments, the motor may be powered by a rechargeable battery pack coupled to the motor. The rechargeable battery pack may be uncoupled from the involute slicer and coupled to a charger for recharging. The battery pack may then be re-coupled to the motor. In other embodiments, the motor may be powered by replaceable (e.g., one-time use) batteries, and/or by coupling the motor to a power outlet (e.g., a wall power socket).

In some embodiments, the blade of the involute slicer may be coupled to the end of a long shaft, whether a single length shaft, extendible, telescoping, etc. The long shaft may allow the involute slicer to reach workpieces that are located at a distance from the user.

The blade may have any suitable orientation with respect to a body of the slicer. For example, the body of the slicer may include a handle configured to be grasped by a user. The handle may have an upper surface and a lower surface. The blade and/or anvil may be oriented vertically, horizontally, or at an angle with respect to the upper surface of the handle.

In some embodiments, the blade may continuously rotate in one direction when powered on. When the blade is powered off, the blade may remain in the position the blade was in when powered off, and continue rotating when powered on again.

In other embodiments, the blade may be biased to a home position. The blade may rotate in a first direction from the home position when the blade is powered on. The path of the blade may include a catch point. If the blade is powered off prior to the blade reaching the catch point, the blade may return to the home position in a second direction, opposite the first direction. If the blade is powered off after reaching the catch point, the blade may continue in the first direction to the home position. In some embodiments, the catch point may be located so that the cutting edge is past the pockets of the anvil when the blade reaches the catch point. This may enhance the safety of the involute slicer.

The catch point may be located so that when large workpieces are totally cut and the blade is powered off, but the blade is not at the home position, the blade proceeds in the first direction to the home position to be ready to cut another workpiece. The involute slicer may include one or more magnets to bias the blade and/or create the catch point. Other embodiments may utilize other methods of determining the location of the blade, including one or more sensors providing information to a control board or other computing device.

In some embodiments, the blade may rotate with a speed of about 20 to about 100 revolutions per minute (rpm), or more specifically about 30 to about 50 rpm. This is far less than typical speeds for involute blades used in other applications, such as meat and cheese slicing, which are typically 600 to 1500 rpm.

In some embodiments, the involute slicer may include a ratchet mechanism to step the blade through its path. The ratchet mechanism may prevent the blade from retreating along the path, and may facilitate cutting through workpieces that require a lot of force to cut through. In an embodiment, such a ratchet mechanism may be powered by hand.

In some embodiments, the slicer may include a protective sheath that at least partially covers the blade. In some embodiments, the protective sheath may fully cover the cutting edge when the blade is in the starting position. As the blade rotates from the starting position, the blade may exit the protective sheath, thereby exposing the cutting edge.

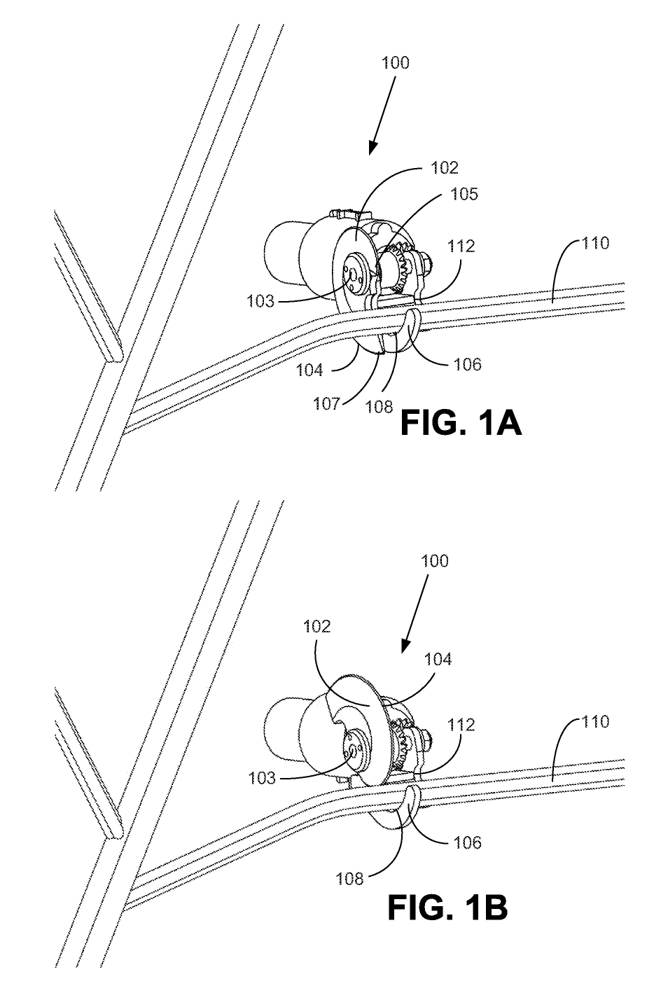

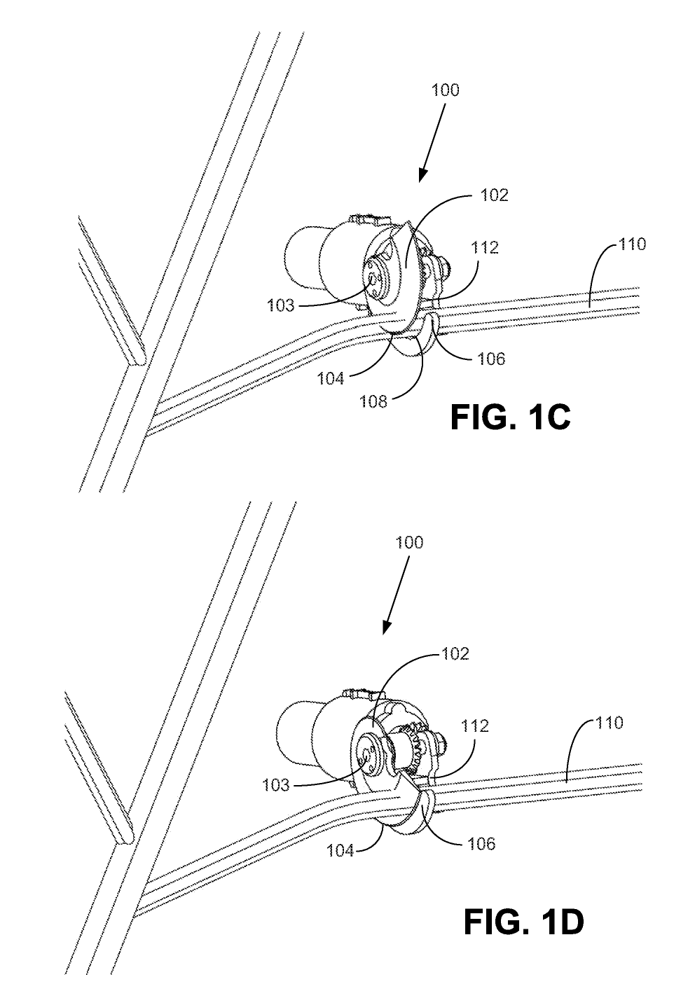

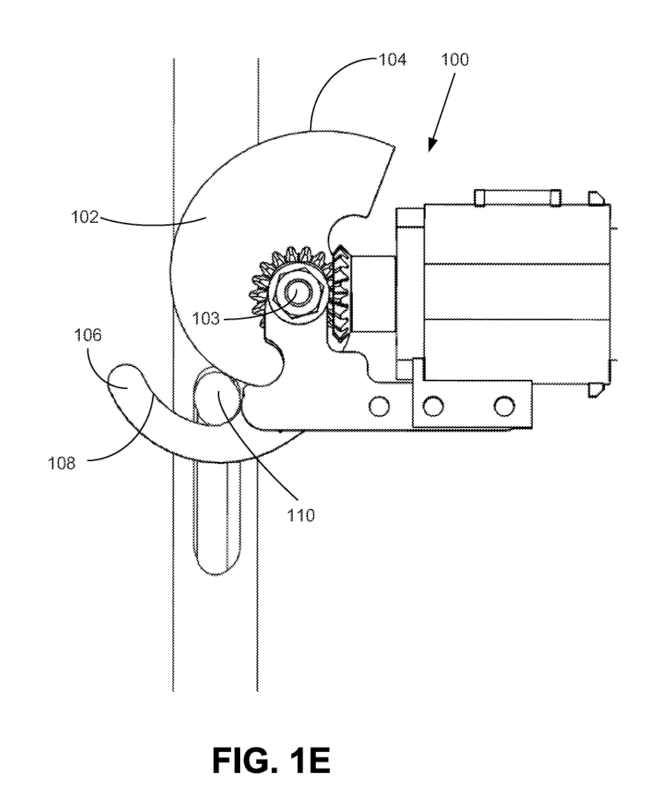

FIGS. 1A-E illustrate an involute slicer 100 including a blade 102 having a cutting edge 104 with an involute shape. The involute slicer 100 further includes an anvil 106 having a pocket 108. Pocket 108 provides support for workpiece 110 while workpiece 110 is cut. The blade 102 rotates about an axis 103 from a home (starting) position (as shown in FIG. 1A) to a finishing position (as shown in FIG. 1D), passing next to anvil 106 and thereby cutting workpiece 110. Anvil 106 includes an additional support structure 112 located on the same side of blade 102 as pocket 108. FIGS. 1B and 1C show intermediate positions of the blade 102 as it rotates from the home position to the finishing position. From the finishing position, the blade 102 may return to the home position in the same direction, or may reverse direction.

The involute shape of the cutting edge 104 provides a radially expanding cutting edge 104 as the blade 102 is rotated. The radius of the cutting edge 104 increases from a proximal end 105 to a distal end 107 (as shown in FIG. 1A). The blade 102 advances into the workpiece 110 while also having a component of motion tangential to the cutting edge 104. The tangential motion decreases the force necessary to cut through the workpiece 110.

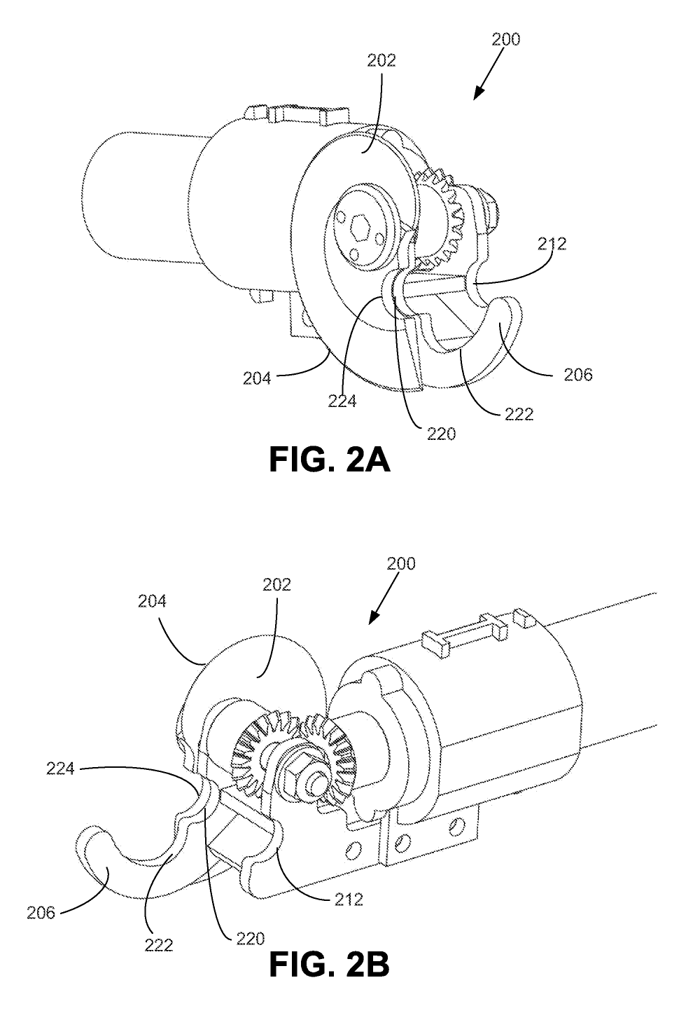

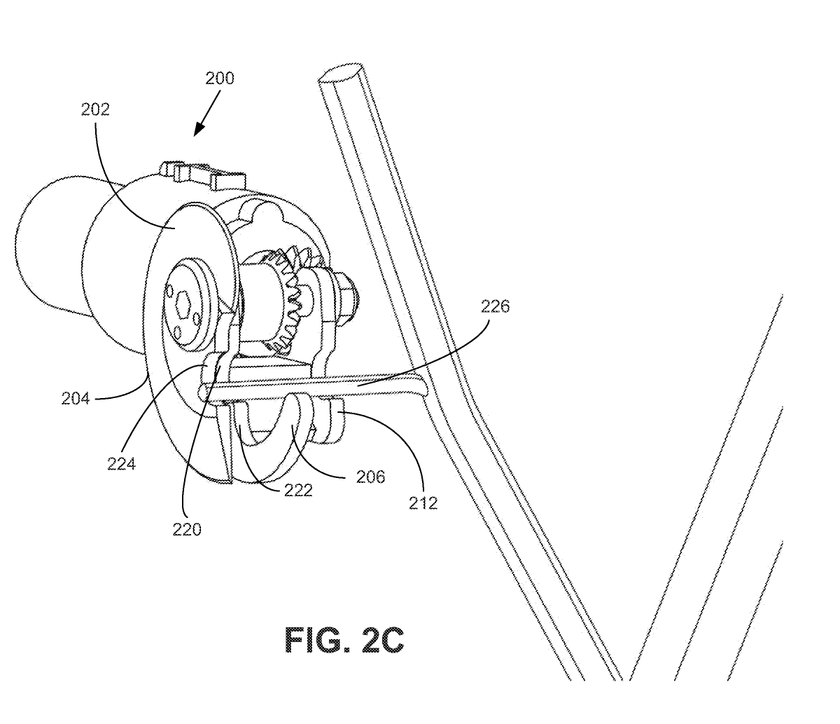

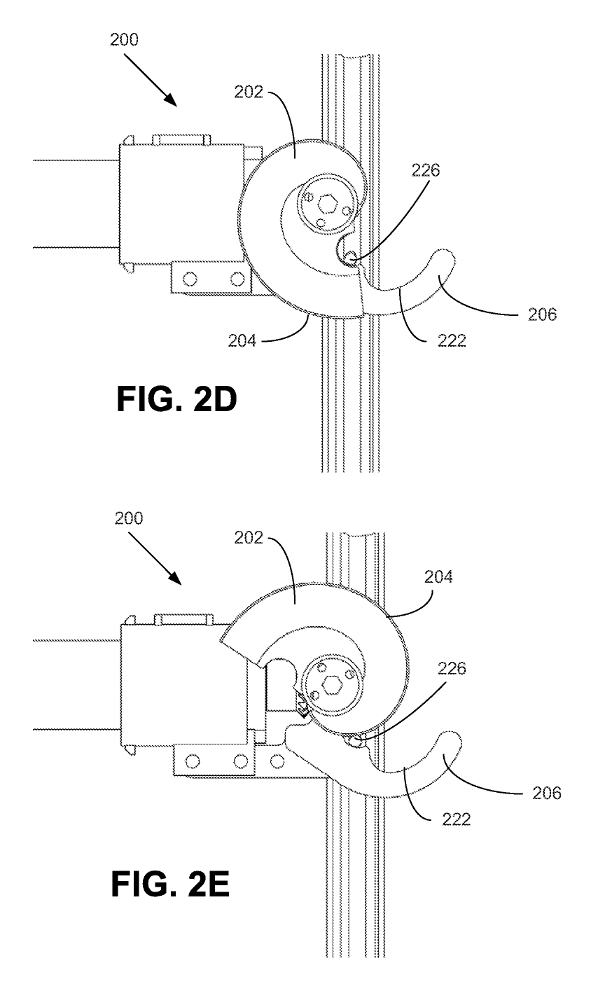

FIGS. 2A-B illustrate an involute slicer 200 having an anvil 206 with a smaller pocket 220 and a larger pocket 222. Smaller pocket 220 provides support for smaller workpieces, while larger pocket 222 provides support for larger workpieces. Involute slicer 200 further includes a blade 202 with a cutting edge 204 having an involute shape. Blade 202 further includes a cutout portion 224 to allow access to the smaller pocket 220 and to allow a longer cutting edge 204. Anvil 206 further includes an additional support structure 212 located on the same side of blade 202 as pockets 220 and 222. Additional support structure 212 has a similar shape to smaller pocket 220 to provide support for smaller workpieces.

FIGS. 2C-E show involute slicer 200 while cutting a smaller workpiece 226. The smaller workpiece 226 is disposed in the smaller pocket 220 while being cut. Blade 202 rotates from a home position (as shown in FIGS. 2C and 2D). FIG. 2E shows blade 202 in an intermediate position. For smaller workpieces such as workpiece 226, blade 202 may not need to rotate as far to complete the cut as for larger workpieces.

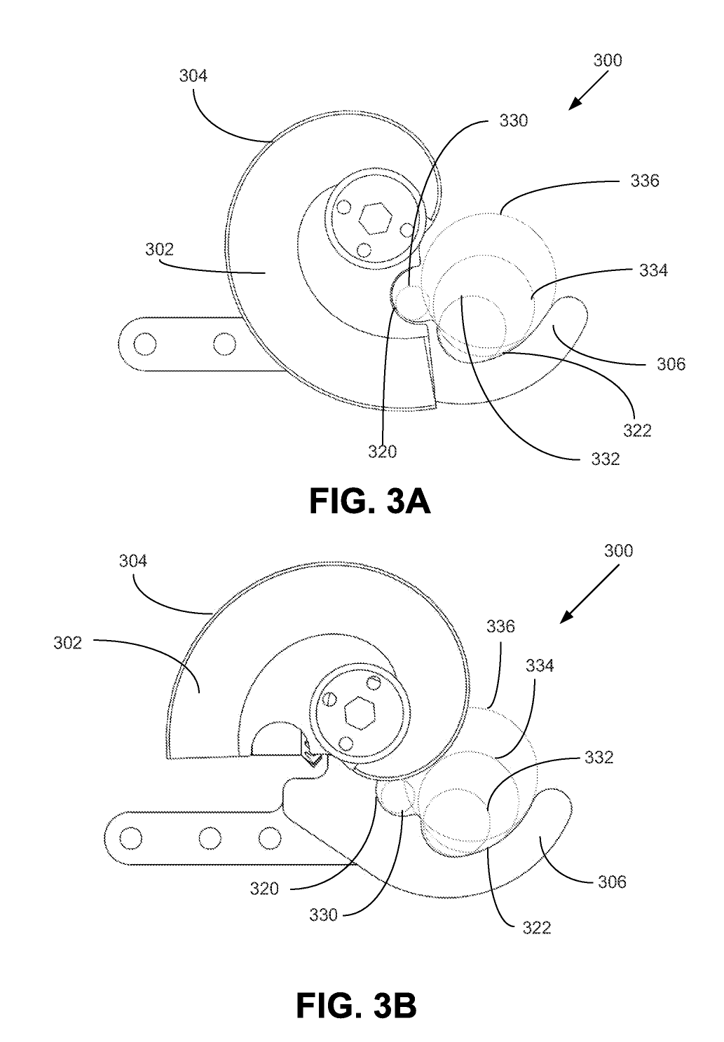

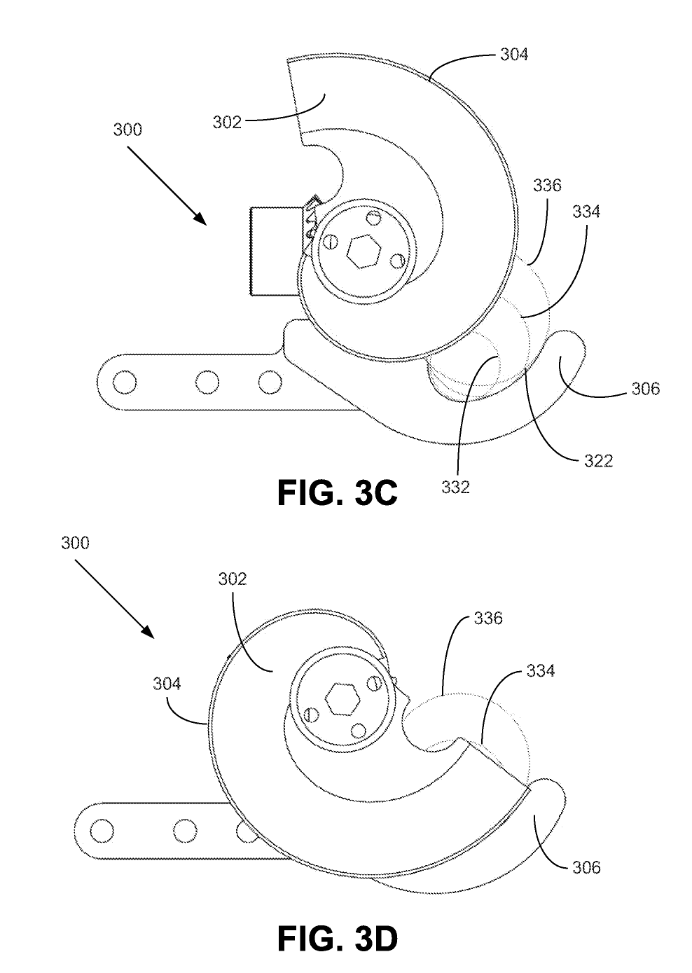

FIGS. 3A-D show an involute slicer 300, including a blade 302 having an involute cutting edge 304, as the blade 302 moves from a home (starting) position (as shown in FIG. 3A) to a finishing position (as shown in FIG. 3D). Involute slicer 300 further includes an anvil 306 with a smaller pocket 320 and a larger pocket 322. FIGS. 3A-D illustrate how the involute slicer 300 may be used with workpieces of varying sizes. Workpieces 330, 332, 334, and 336 are shown with increasing diameters. The smaller pocket 320 and/or larger pocket 322 of anvil 306 may provide support for a wide variety of workpiece sizes, allowing involute slicer 300 to be used to cut any of workpieces 330, 332, 334, and/or 336. The smaller workpiece 330 may be disposed in the smaller pocket 320 during cutting, while the larger workpieces 332, 334, and 336 may be disposed in the larger pocket 322 during cutting.

If the blade 302 is powered off shortly after completing the cut of the smaller workpiece, the blade 302 may reverse direction to return to the home position. However, if the blade 302 travels past a catch point (not shown), the blade 302 will continue in the same direction to return to the home position.

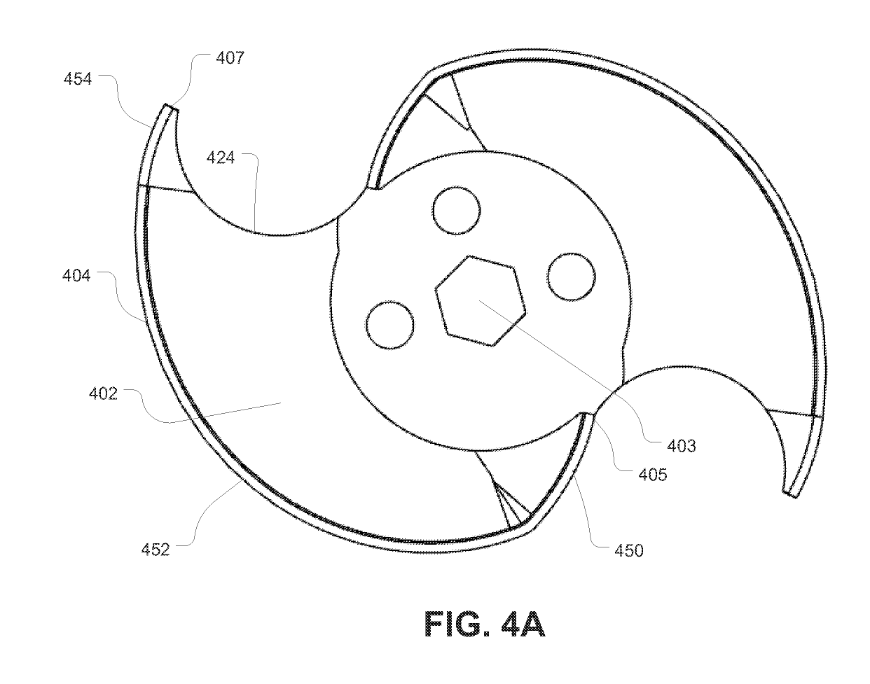

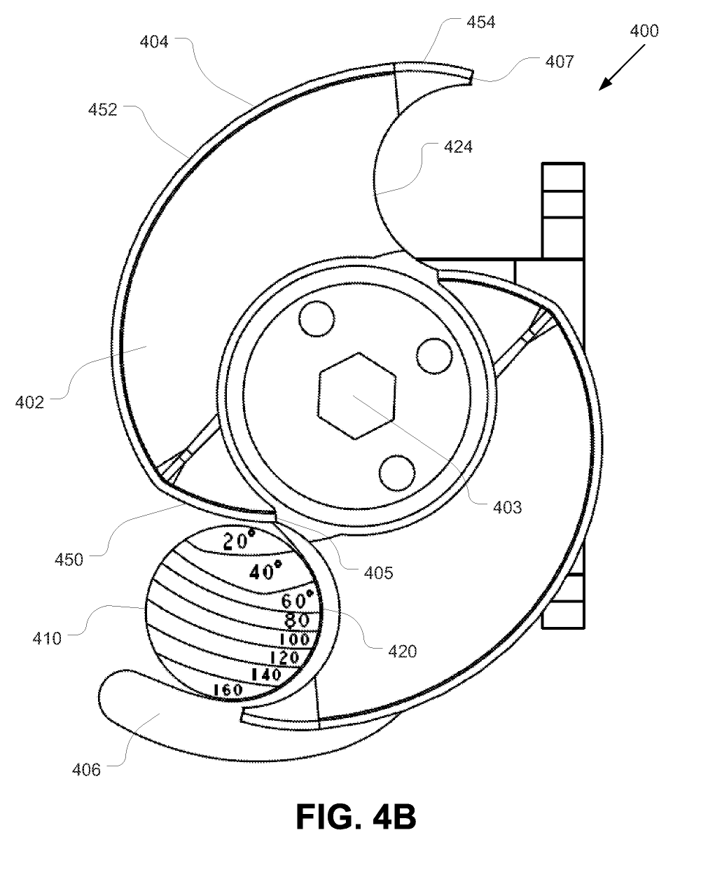

FIG. 4A illustrates a blade assembly 402 for an involute slicer having two cutting edges 404. Both cutting edges 404 are configured to rotate about an axis 403. Additionally, the cutting edges 404 are coplanar. Having two cutting edges 404 may allow the blade assembly 402 to cut two workpieces with each rotation. Additionally, or alternatively, the two cutting edges 404 may allow each cutting edge 404 to complete a cut with less rotation of the blade assembly 402 and/or prevent having to fully rotate the cutting edge 404 back around to the home position to start another cut.

Each cutting edge 404 further includes a proximal end 405 and a distal end 407. A radius of the cutting edge 404 increases from the proximal end 405 to the distal end 407 in an involute manner. Each cutting edge 404 further includes a plurality of regions with different ratios of radial expansion versus tangential travel. A first region 450, closest to the proximal end 405, has a first ratio of radial expansion versus tangential travel. A second region 452, located adjacent the first region 450 and further from the proximal end 405, has a second ratio of radial expansion versus tangential travel. A third region 454, adjacent the second region 452 and closest to the distal end 407, has a third ratio of radial expansion versus tangential travel. The first ratio is greater than the second ratio, and the second ratio is less than the third ratio.

Other embodiments may include more or less regions than are shown in FIG. 4A. For example, in some embodiments, the cutting edge 404 may include only the first region 450 and second region 452, with the second region 452 extending to the distal end 407.

The high first ratio may allow the cutting edge 404 to quickly shear through smaller diameter workpieces, which may not require high force to cut through, and/or starting the cut of larger workpieces where the cross-section is small. The smaller second ratio may allow the cutting edge 404 to cut through larger diameter workpieces with less force applied than would be necessary with a higher second ratio. The high third ratio of the third region 454 may be suitable for finishing cuts of larger workpieces. Accordingly, the second region 452 may cut through the center of the workpiece where more force is needed, and the third region 454 may be used to quickly finish the cut when less of the workpiece remains to be cut.

For example, FIG. 4B illustrates an involute slicer 400 with the blade assembly 402 in the home position and ready to cut a workpiece 410. The workpiece 410 is supported by an anvil 406. FIG. 4B shows the portions of the workpiece 410 that are cut as the blade assembly 402 rotates from the home position. As shown, during about the first 40 degrees of rotation of the blade assembly 402, the workpiece 410 is cut by the first region 450 of cutting edge 404. From about 40 degrees to about 140 degrees of rotation, the workpiece 410 is cut by the second region 452 of cutting edge 410. From about 140 degrees to about 160 degrees of rotation, the workpiece 410 is cut by the third region 454 to finish the cut. It will be apparent that the embodiment of FIG. 4B is merely an example, and other embodiments may include different arrangements of the regions.

As shown, the first ratio is greater than the third ratio. However, in other embodiments, the first ratio may be less than or equal to the third ratio. In some embodiments, the third ratio may be selected so that the cutting edge 404 has a single moving point of intersection along the anvil 406 (e.g., crosses the anvil at only one location) as the blade 402 is rotated. The single moving point of intersection progresses towards the distal end 407 of the blade 402 as the blade 402 rotates in the first direction. This single moving point of intersection provides immediate support to the approaching portions of the blade that will slide by the anvil.

If the third ratio is too large, then the cutting edge 404 may have two moving points of intersection along the anvil 406. The second point of intersection may not have immediate support, which may allow the blade to be deflected at or near the second point of intersection, thereby causing the blade to contact the upper surface of the anvil instead of slide along the side. This may cause the blade 402 to break at the distal end 407, and/or cause damage/wear on the distal end 407 and/or anvil 406.

The cutting edges 404 further include a cutout portion 424 between the distal end 407 and the axis 403. The cutout portion 424 is substantially aligned with a pocket 420 of an anvil 406.

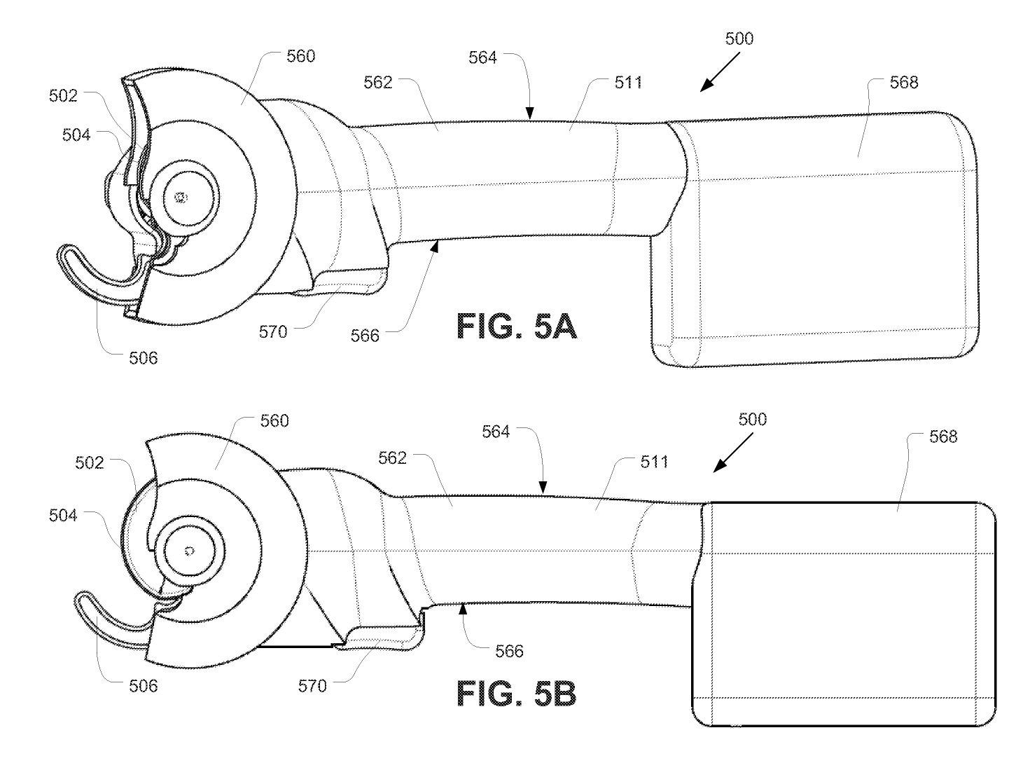

FIGS. 5A and 5B illustrate a battery-powered slicer 500 in accordance with various embodiments. The slicer 500 includes a blade 502 disposed in a protective sheath 560. When the blade 502 is in a home (starting) position, as shown in FIG. 5A, a cutting edge 504 of the blade is entirely covered by the protective sheath 560. As the blade 502 rotates, the cutting edge 504 exits the protective sheath 560. For example, FIG. 5B shows the blade 502 in an intermediate position with a portion of the cutting edge 504 disposed outside the sheath 560.

The slicer 500 further includes a body 511 coupled to the blade 502 and anvil 506. The body 511 includes a handle 562 having an upper surface 564 and a lower surface 566. The blade 502 extends from the body 511 and is oriented vertically with respect to the upper surface 564 and lower surface 566 (e.g., so that if the upper surface is parallel to the ground, the blade will be perpendicular to the ground). The anvil 506 is also oriented vertically with respect to the upper surface 564 (e.g., below the blade 502.

The body 511 further includes a battery pack 568 to provide power for rotating the blade 502. A trigger 570 is disposed on the lower surface 566 of the handle 562 and is used to selectively turn the rotation of blade 502 on and/or off.

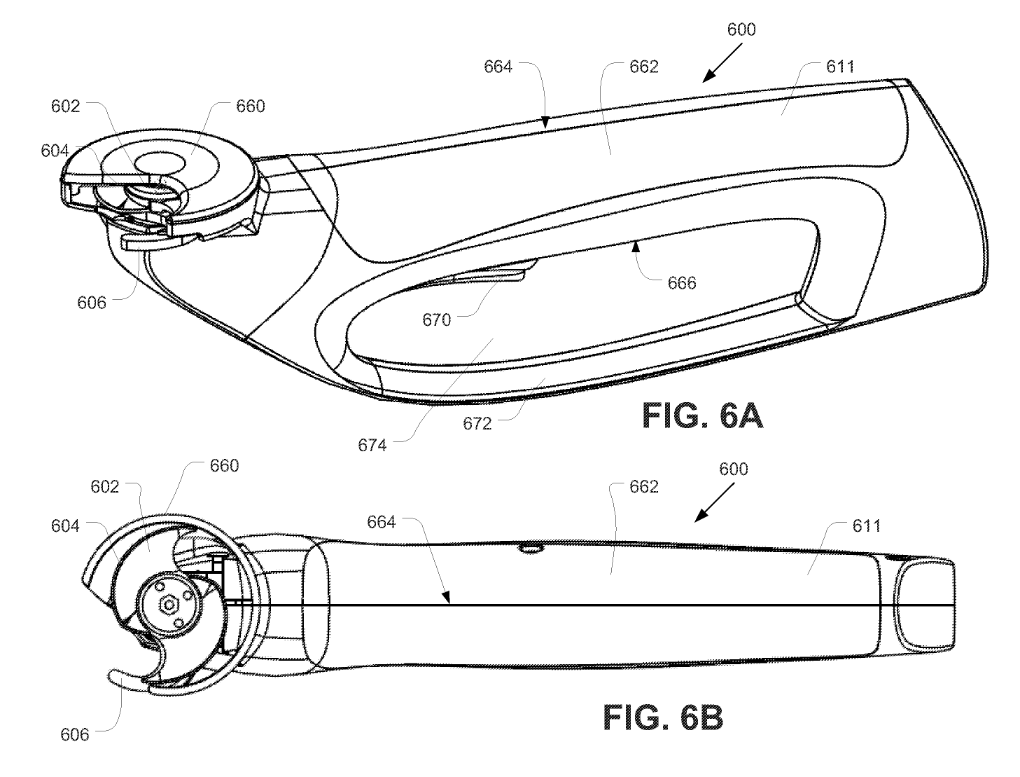

FIGS. 6A and 6B illustrate a slicer 600 having a blade 602 and an anvil 606 oriented in a horizontal position. The slicer 600 includes a body 611 with a handle 662. The handle 662 includes an upper surface 664 and a lower surface 666. The blade 602 and anvil 606 are oriented in a horizontal position with respect to the upper surface 664 and lower surface 666 (e.g., so that if the upper surface is parallel to the ground, the blade will also be parallel to the ground). The slicer 600 also includes a bottom bar 672 that defines an opening with lower surface 666. A trigger 670 is disposed on the lower surface 666 for turning the rotation of blade 602 on and/or off.

The blade 602 is disposed in a protective sheath 660. FIG. 6B illustrates the slicer 600 with a top cover of the protective sheath 660 removed to show the blade 602.

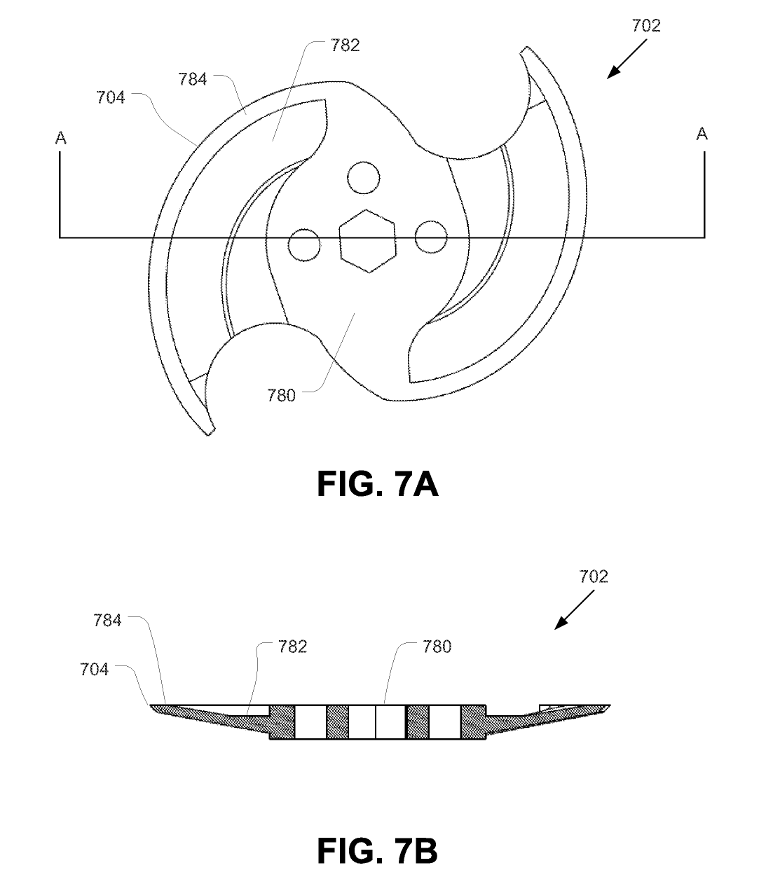

FIGS. 7A and 7B illustrate a blade 702 having a back side 780 including a relief portion 782 that is recessed from a sliding surface 784. The sliding surface 784 is adjacent to a cutting edge 704 of the blade 702. The sliding surface 784 is disposed along the entire length of cutting edge 704. The sliding surface 784 may contact the anvil of the slicer as the cutting edge 704 passes adjacent to the anvil. The relief portion 782 may be recessed away from the anvil so that the relief portion 782 does not contact the anvil as the blade rotates. This may provide a low contact area between the blade 702 and the anvil. The relief portion 782 may facilitate a lower cutting force and/or provide a straighter cut for blade 702 compared with blades that are flat on the back side.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A slicer comprising:
an anvil configured to provide support for a workpiece; and
a blade having a cutting edge with a radius that increases from a proximal end of the cutting edge to a distal end of the cutting edge, the blade configured to rotate about an axis and pass next to the anvil to cut the workpiece.

2. The slicer of claim 1, wherein the cutting edge has an involute shape.

3. The slicer of claim 1, wherein the cutting edge has a first region having a first ratio of radial expansion versus tangential travel and a second region having a second ratio of radial expansion versus tangential travel, wherein the second ratio is different from the first ratio.

4. The slicer of claim 3, wherein the first region is closer to the proximal end than the second region, and wherein the first ratio is greater than the second ratio.

5. The slicer of claim 4, wherein the cutting edge further includes a third region that is closer to the distal end than the second region, wherein the third region has a third ratio of radial expansion versus tangential travel that is greater than the second ratio.

6. The slicer of claim 5, wherein the third ratio is less than the first ratio.

7. The slicer of claim 3, wherein the first region is closer to the proximal end than the second region, and wherein the second ratio is greater than the first ratio.

8. The slicer of claim 7, wherein the cutting edge further includes a third region that is closer to the distal end than the second region, wherein the third region has a third ratio of radial expansion versus tangential travel that is less than the second ratio.

9. The slicer of claim 1, wherein the anvil includes a first pocket and a second pocket, the first pocket located closer to the axis than the second pocket and configured to support smaller workpieces than the second pocket.

10. The slicer of claim 1, further comprising a motor configured to rotate the blade in a first direction when the blade is powered on.

11. The slicer of claim 10, wherein the blade is biased to a home position, wherein the slicer further includes a catch point, and wherein if the blade is powered off when the blade is disposed past the home position and before the catch point in the first direction, the blade will return to the home position in a second direction opposite the first direction.

12. The slicer of claim 1, wherein the blade is configured to rotate at a speed of between about 20 to about 100 revolutions per minute.

13. The slicer of claim 1, wherein the cutting edge is a first cutting edge, and wherein the blade further comprises a second cutting edge that is coplanar with the first cutting edge.

14. The slicer of claim 1, wherein the blade includes a cutout portion between the distal end of the cutting edge and the axis.

15. The slicer of claim 14, wherein the cutout portion is substantially aligned with a pocket of the anvil when the blade is in a home position.

16. The slicer of claim 1, further comprising a body coupled to the blade and the anvil and having a handle with an upper surface, wherein the blade is oriented vertically with respect to the upper surface.

17. The slicer of claim 1, further comprising a body coupled to the blade and the anvil and having an upper surface, wherein the blade is oriented horizontally with respect to the upper surface.

18. The slicer of claim 1, wherein the cutting edge includes a serrated portion and a smooth portion.

19. The slicer of claim 1, wherein a back side of the blade includes a sliding surface adjacent the cutting edge and a relief portion that is recessed from the sliding surface.

20. A slicer comprising:
a body;
an anvil coupled to the body and configured to provide support for a workpiece; and
a blade assembly coupled to the body and configured to rotate about an axis and pass next to the anvil, the blade having first and second cutting edges with a radius that increases from a proximal end of the cutting edge to a distal end of the cutting edge.

21. The slicer of claim 20, wherein the first and second cutting edges are coplanar.

22. The slicer of claim 20, wherein the first and second cutting edges have an involute shape.

23. The slicer of claim 20, wherein the first and second cutting edges have a first region with a first ratio of radial expansion versus tangential travel and a second region with a second ratio of radial expansion versus tangential travel, wherein the first region is closer to the proximal end of the cutting edge than the second region, and wherein the first ratio is different from the second ratio.

24. The slicer of claim 23, wherein the first and second cutting edges further include a third region that is closer to the distal end than the second region, wherein the third region has a third ratio of radial expansion versus tangential travel that is different from the second ratio.

25. The slicer of claim 20, wherein the anvil includes a first pocket and a second pocket, the first pocket located closer to the axis than the second pocket and configured to support smaller workpieces than the second pocket.

26. The slicer of claim 20, further comprising a motor disposed in the body and configured to rotate the blade in a first direction when the blade is powered on.

27. The slicer of claim 26, wherein the motor is configured to rotate the blade at a speed of between about 20 to about 100 revolutions per minute.

28. The slicer of claim 20, wherein the first and second blades include a cutout portion between the distal end of the cutting edge and the axis.

29. The slicer of claim 20, further comprising a protective sheath coupled to the body, the protective sheath configured to cover at least a portion of the first cutting edge and/or second cutting edge.

30. The slicer of claim 29, wherein the body is configured to completely cover the first and second cutting edges when the blade assembly is in a home position.
